(19) United States
(12) Patent Application Publication
(10) Pub. No.: US 2007/0102410 A1
(43) Pub. Date: May 10, 2007

(54) Torch hex end structure

(75) Inventor: Frank Zamuner, Oakville (CA)

Correspondence Address: FAY SHARPE / LINCOLN, 1100 SUPERIOR AVENUE, SEVENTH FLOOR, CLEVELAND, OH, 44114, US

(73) Assignee: Lincoln Global, Inc.

(21) Appl. No.: 11/268,085

(22) Filed: Nov. 7, 2005

(51) Int. Cl. B23K 9/12

(52) U.S. Cl. 219/137.31

(57) ABSTRACT

A welding gun assembly for directing a welding wire toward a workpiece, having a torch at a forward portion of the gun; a welding wire feeder at a rearward portion of the gun; a first housing positioned adjacent the torch; and a second housing positioned adjacent the wire feeder. The second housing has a hexagonally shaped opening for receiving a conduit having a hexagonal portion. The conduit is positioned in one of six positions in the housing. The first housing has a hexagonal shape for being mounted to a hexagonal opening of a remote arm. A block having a hexagonal shape is received within a hexagonal opening of the housing. A hexagonal conduit is received within the block and secured in one of six positions.

### BACKGROUND

The invention relates to the art of electric arc welding and more particularly to an improved torch for the gun between a wire feeder and the welding operation.

### INCORPORATION BY REFERENCE

The design of the torch at the welding end of a gun is the subject of many patents that describe the background of the present invention. Some of these patents and/or applications are United Kingdom Application No. 2,285,404; Canadian Application No. 2,106,837; Canadian Application No. 2,139,152; European Application No. 0 590 728 A1; and U.S. Pat. No. 5,313,046. These prior art examples of the torch to which the present invention is directed are incorporated by reference herein as background information and to describe some of the attributes required for a torch of the type to which the invention is directed.

### BACKGROUND OF THE INVENTION

In electric arc welding, a gun is a flexible, elongated element having a rear end connected to a wire feeder and a front end for a welding torch. The gun includes an elongated flexible conduit directing current and shielding gas from the wire feeder to the welding torch. Such a mechanism is employed for hand held welding and for robotic controlled welding in the trade.

The torch includes a contact tip through which the welding wire is directed from the wire feeder through the flexible tube to the welding operation. This tip is supported in a conductive cylindrical assembly receiving power from the wire feeder.

Shielding gas is directed from a diffuser in the cylindrical assembly into a chamber defined by an outer nozzle through the nozzle into the area around the contact tip so the shielding gas forms a protective layer between the molten metal of the welding operation and atmosphere. All of these requirements of a torch require complex machined components at the end of the torch which substantially increases the cost and adversely affects the operability of the torch during the welding operation. Furthermore, the welding operation itself creates spatter, especially during short circuit conditions so the forward end of the torch including the contact tip and diffuser is subject to substantial deterioration over time caused by spatter together with the tremendous arc temperature involved in the welding operation.

Shielding gas is directed into the welding operation from diffuser orifices circumferentially spaced around the torch and directed ultimately to the contact tip at the welding operation. Consequently, torches have diffuser orifices for shielding gas; however, these orifices must be oriented to prevent unwanted cavitation. It has been found that these orifices should be as close as possible to the welding operation. Such closeness drastically increases the tendency for spatter to affect the laminar flow of shielding gas from the diffuser orifices.

Robotic assemblies are commonly used with welding guns. Previously, when robotic gun assemblies were dismantled, the down time was extensive because there was no quick and easy means to precisely reassemble the robotic gun. A previous example of a keyed alignment system for a welding torch used with a robotic gun assembly is shown in U.S. Pat. No. 5,451,117 which is hereby incorporated by reference. A mounting arm which provides for various methods of changing position of the welding gun with respect to the robotic arm and the position of the gun with respect to its housing as well as providing easy disassembly of the gun from the robotic arm is described in co-pending application Ser. No. 11/178,819, filed on Jul. 11, 2005, which is also incorporated herein by reference.

Furthermore, a welding gun which allows for various positions of the forward end and rear end of the gun is needed without completely disassembly of the gun. Accordingly, it is considered desirable to provide a welding gun which allows various positions of the welding gun with respect to the robotic assembly and with respect to the handle without completely disassembling either the gun or the robotic assembly. The ability to supply anti-spatter liquid and an air purge is also desirable.

### SUMMARY OF THE INVENTION

The present invention is directed to a welding gun. In particular, the invention is directed to a welding gun having a front end housing adjacent a welding torch and a rear end housing adjacent a welding wire feeder.

The present invention provides a hexagonally shaped housing and conduit for positioning the gun in several positions with respect to a robotic mounting arm. More particularly, a welding gun assembly is provided for directing a welding wire toward a workpiece, having a torch at a forward portion of the gun; and a welding wire feeder at a rearward portion of the gun. A first housing is positioned adjacent the torch and a second housing is positioned adjacent the wire feeder. The second housing has a first, cylindrical opening and a second, hexagonally shaped opening adjacent the first opening. A first conduit is selectively received within the second housing. The conduit has a first cylindrical portion and a second hexagonal portion having a plurality of outer walls. The first cylindrical portion is received within the cylindrical opening and the second, hexagonal portion is received within the hexagonal opening of the second housing. The first conduit further has an opening therethrough for receiving welding wire. The second housing has an opening in a wall thereof to receive shielding gas to a cavity of the housing formed by the cylindrical opening and the hexagonal opening.

In accordance with another aspect of the invention, a housing assembly for use with a welding gun assembly for directing a welding wire toward a workpiece includes a housing having a first, cylindrical opening and a second, hexagonally shaped opening adjacent the first opening. A conduit is selectively received within the housing. The conduit has a first cylindrical portion and a second hexagonal portion comprising a plurality of outer walls. The first cylindrical portion is received within the cylindrical opening and the second, hexagonal portion is received within the hexagonal opening of the housing. The conduit further has an opening formed in each of the outer walls. The housing has an opening in a wall thereof to receive a fastener extending therethrough. The housing opening is aligned with one of the openings in the outer walls of the conduit and the fastener extends through the housing opening and one of the openings of the outer walls of the conduit.

In accordance with yet another aspect of the invention, a housing for use with a welding gun assembly has a first, hexagonal portion and a second, cylindrical portion, a first hexagonal opening and a second, cylindrical opening. A block has a plurality of walls forming a hexagonal shape. The block has a hexagonal shaped opening therein. A conduit having a hexagonal shaped portion and a cylindrical portion extending through the cylindrical portion. The hexagonal portion of the conduit is selectively received with the hexagonal shaped opening of the block.

According to another aspect of the invention, a welding gun assembly has a housing; a conduit extending through the housing; and a block housed within the housing, wherein the block has a passageway in one of outer walls of the block for receiving an outlet of an anti-spatter liquid supply tube or an outlet for air purging.

According to still another embodiment of the present invention, a welding gun assembly has a housing, and a block mounted within the housing, wherein the block has a plurality of sockets for receiving pipe-spigots of power cables, and a welding wire tube wherein the block has a passageway fluidly connecting one of the sockets for the pipe-spigots of the power cables to the socket for the pipe-spigot for the welding wire tube, wherein the passageway feeds anti-spatter liquid or an air purge to the pipe-spigot for the welding wire tube.

One advantage of the present invention is the provision of mounting a conduit to a housing of the welding gun in several positions without completely disassembling the gun.

Another advantage of the present invention is the provision of mounting the gun to a remote arm in one of several positions without completely disassembling the gun.

Yet another advantage of the present invention is the provision of providing a shielding gas through the housing to the conduit.

Another advantage of the present invention is the provision of providing anti-spatter liquid or an air purge to the welding gun.

Still other advantages and aspects of the invention will become apparent through the following description and the accompanying drawings.

### BRIEF DESCRIPTION OF THE DRAWINGS

The invention may take form in certain components and structures, a preferred embodiment of which is illustrated in the accompanying drawings wherein:

FIG. 1 is a side elevational view of a welding gun connected to a robotic arm in accordance with a preferred embodiment of the present invention;

FIG. 2 is an enlarged side elevational view of the rear end of the gun in accordance with a preferred embodiment of the present invention;

FIG. 3 is an enlarged view in partial cross-section of the rear end of the gun of FIG. 2;

FIG. 4 is a cross-sectional view of the rear end of the gun of FIG. 3;

FIG. 5 is a sectional view along line 5-5 of FIG. 4;

FIG. 6 is a sectional view along line 6-6 of FIG. 4;

FIG. 7 is a sectional view along line 7-7 of FIG. 4;

FIG. 8 is a sectional view along line 8-8 of FIG. 4;

FIG. 9 is a sectional view along line 9-9 of FIG. 4;

FIG. 10 is an exploded perspective view of the rear end of the torch of FIG. 3;

FIG. 11 is a side elevational view of the front end of the torch of FIG. 1:

FIG. 12 is an enlarged side elevational view in partial cross-section of the front end of the torch of FIG. 1;

FIG. 13 is a sectional view along line 13-13 of FIG. 12;

FIG. 14 is a sectional view along line 14-14 of FIG. 12;

FIG. 15 is an exploded perspective view of the front end of the welding gun of FIG. 1;

FIG. 16 is an enlarged side elevational view of the front end of the gun in accordance with an alternate embodiment of the present invention;

FIG. 17 is a sectional view, take along line 17-17 of FIG. 16;

FIG. 18 is a side elevational view, in partial cross-section, of the front end of the torch of FIG. 16; and,

FIG. 19 is a sectional view taken along line 19-19 of FIG. 18.

### DETAILED DESCRIPTION OF THE PREFERRED EMBODIMENTS

The apparatus shown in the accompanying drawings and described below are examples which embody the invention. It should be noted that the scope of the invention is defined by the accompanying claims, and not necessarily by specific features of exemplary embodiments.

For a welding operation of the type which the invention is concerned, it is the usual practice to provide a service station. This service station provides: a welding current of electricity; anti-oxidizing gas; a motor for feeding welding wire to the weld; and, optionally, a vacuum source for extracting fumes.

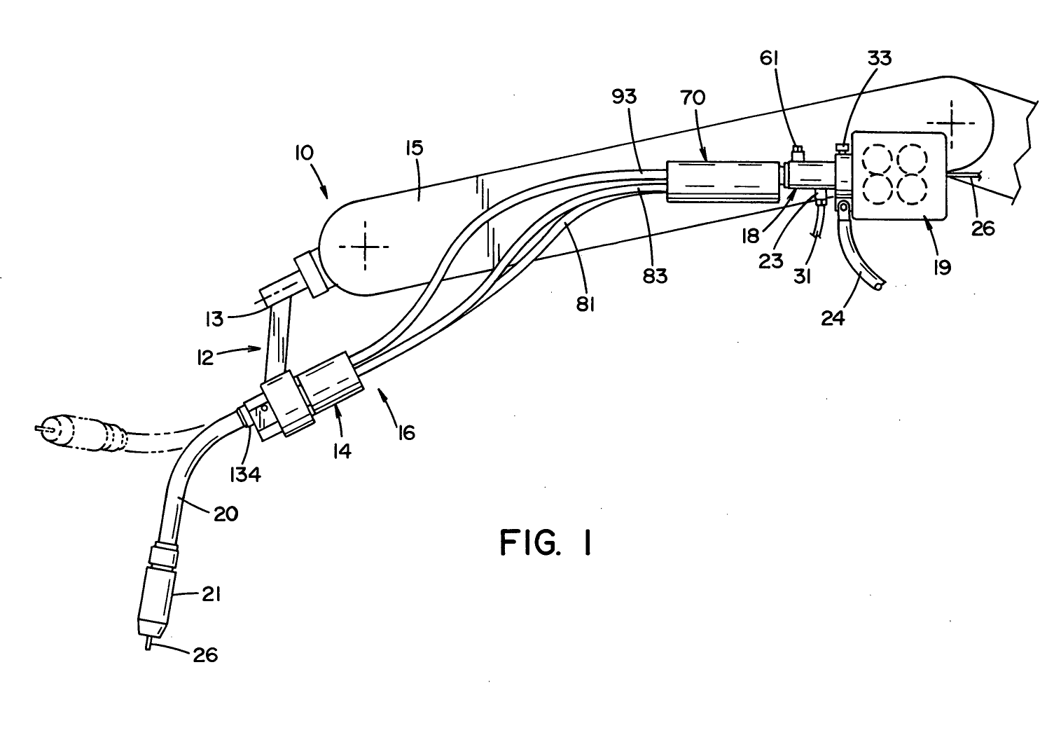

Referring now to FIG. 1, a robotic arm assembly generally designated by the numeral 10 includes a welding gun mount arm 12, a welding gun front or first housing 14 and a welding gun assembly 16. The gun mount arm 12 is a precision made instrument, typically manufactured from an aluminum alloy, preferably from 6061 aluminum alloy or the like. The gun mount arm 12 of the preferred embodiment is rotatably secured at a distal end 13 to a remote robotic machine arm 15. The gun front housing 14 is preferably made of a plastic that is capable of maintaining its shape under tight clamping pressure. The housing is installed at a first or front end of the gun assembly. A second cylindrically shaped gun housing 18, preferably made of brass, is installed at a second, or rear end of the gun assembly adjacent a welding wire feeder assembly 19.

The welding torch further includes a gooseneck 20 which can be an insulated, thick walled copper conductor tube that is wrapped in an aluminum or stainless steel jacket that is capable of dissipating heat quickly. The gooseneck extends from the front housing 14. Although the gooseneck 20 as shown in FIG. 1 is bent at a particular angle, the gooseneck may be manufactured to be straight or bent at any desired angle. The torch of the preferred embodiment further comprises a thick walled nozzle 21 machined from hard drawn copper and typically has a highly conductive copper tip. The arrangement of the nozzle 21 is conventional and accordingly is not described in detail herein.

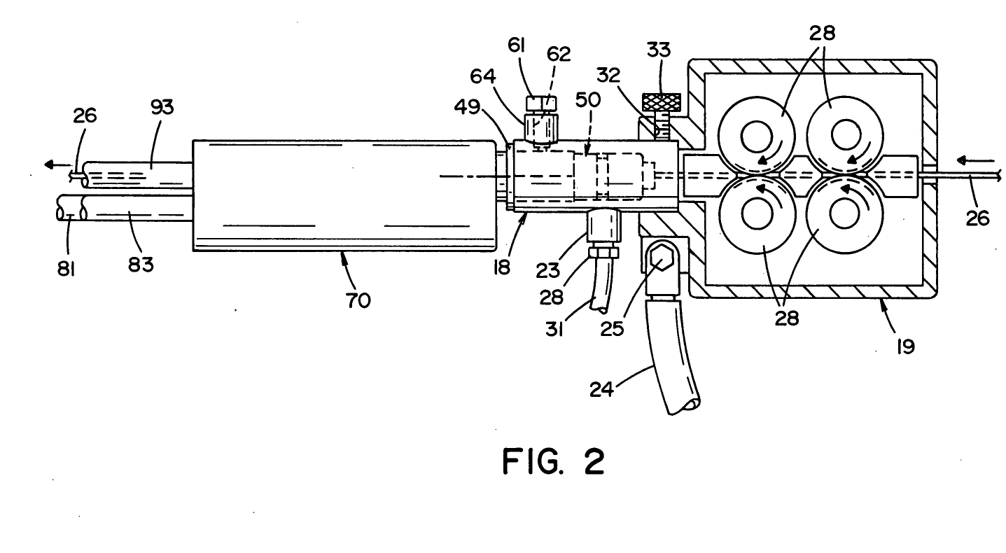

Referring now to FIG. 2, the rear housing 18 is connected to the source of welding current in the welding wire feeder 19. An anti-oxidizing shielding gas, such as argon, carbon dioxide, or other gas as required, is fed into the housing, via a port 23. A tube 31 is threadably connected via nut 28 to the port 23. A conventionally used power line 24 is further connected to the wire feeder 19 via a bolted connection 25. The wire feeder housing is secured to the housing 18 via a bolt or other suitable fastener 33 threadably inserted into opening 32 of feeder housing 19.

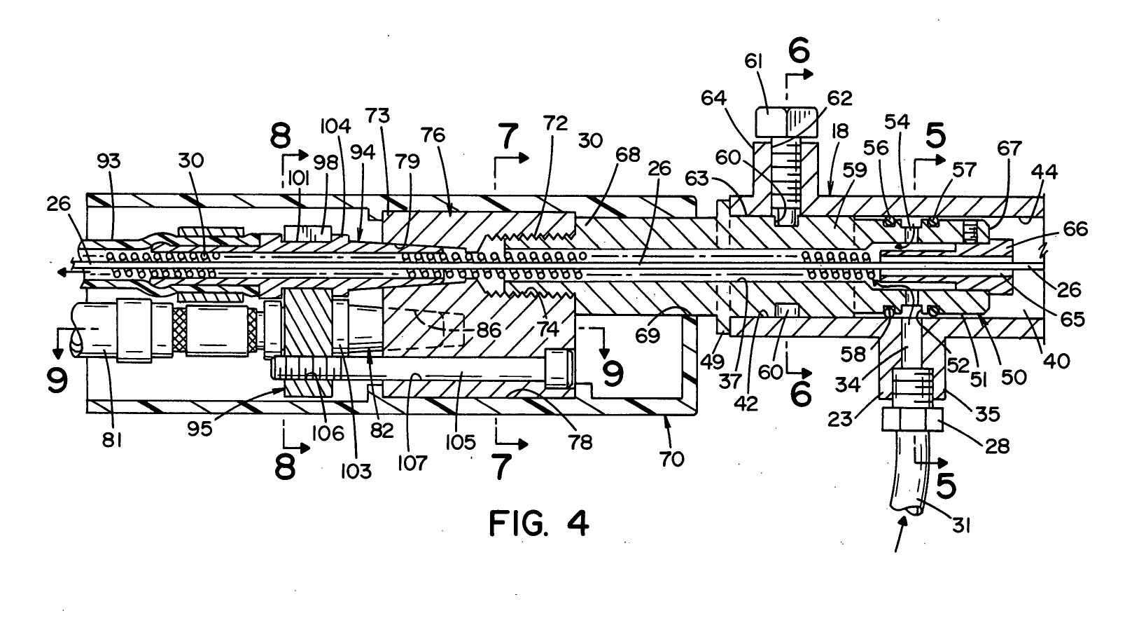

Welding wire 26 is inserted into the housing 18; the wire is on a set of motorized reels 28 in wire feeder 19; whereby the wire may be fed forward controllably, in a conventional manner. The wire 26 may be received inside a close-coiled helical spring 30, (FIG. 4) which serves as a guide for the wire on its passage to the welding torch. A length of plastic tubing 31 is fitted to the housing 18; gas from the port 23 is conveyed inside the tubing to the housing. The above-described arrangements for supplying the welding current, the welding wire, and the gas, into the flexible conduit follow conventional practice as is well known in the welding art.

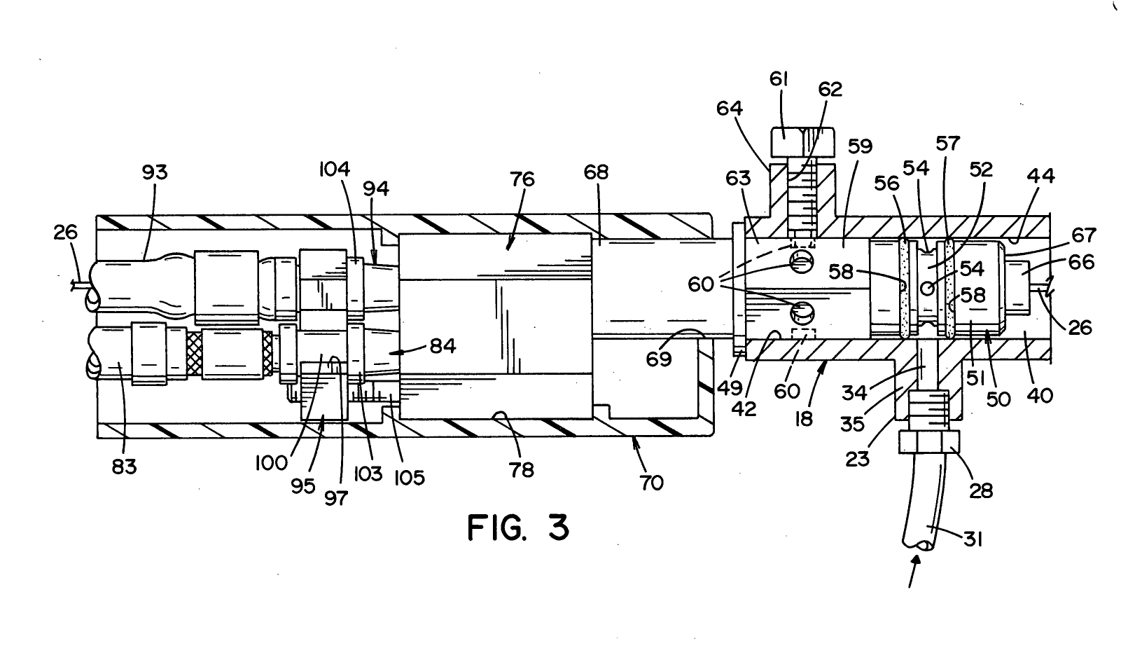

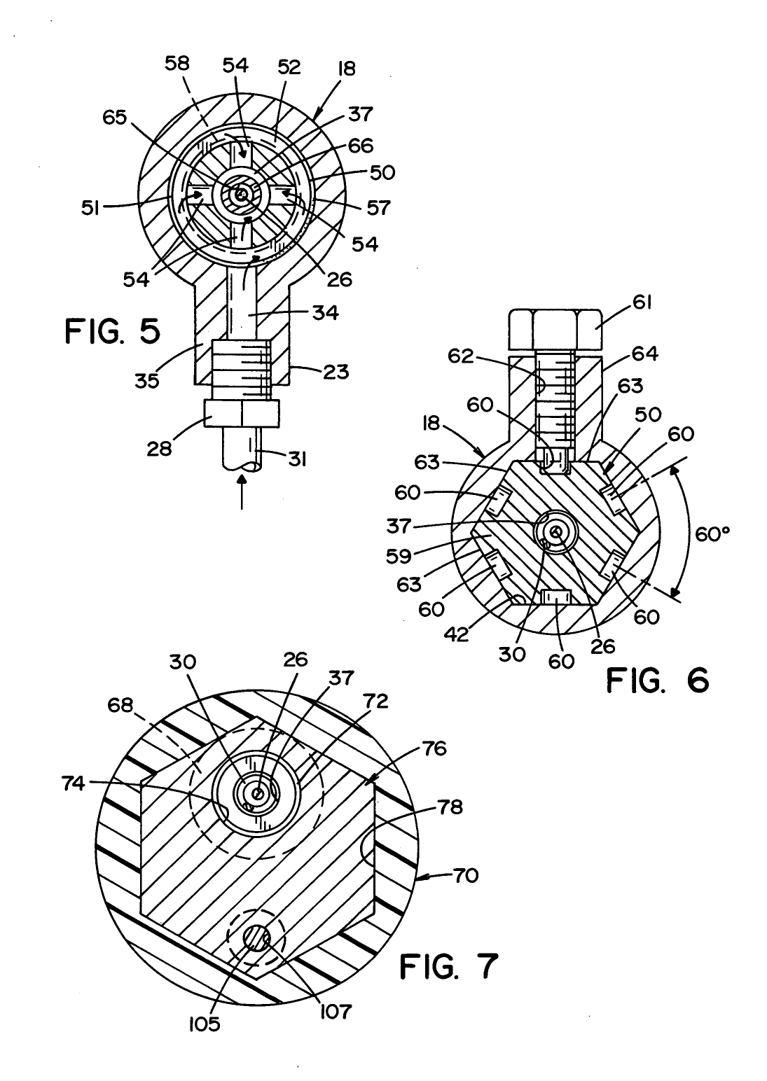

Referring now to FIG. 3, second housing 18 has a hollow internal cavity 40 which has a hexagonal shaped portion 42 (shown in FIG. 6) and a circular shaped portion 44 (shown in FIG. 5). A conduit 50, preferably formed of brass, including a cylindrical section 51 is received within portion 44 of the housing. As seen in FIG. 5, conduit 50 has an opening 37 found therein for receiving welding wire 26. As seen in FIG. 5, the conduit has a grooved section 52 which has a plurality of openings 54 spaced approximately 90° apart. The holes serve as passageways for gas which enters the housing via tubing 31 into opening 37 about welding wire 26 and through opening 34 in arm 35 extending from housing 18. A pair of O-rings 56, 57 or other suitable sealing material is received within grooves 58 of the conduit to seal and prevent gas from traveling or escaping into the cavity 40 of the housing 18. The conduit 50 also has a hexagonal shaped portion 59 which is selectively received by hexagonal shaped opening 42 of housing 18.

The hexagonal shape of the conduit 50 allows the welding torch to be installed in different positions in the housing. Specifically, the hexagonal portion 59 has six holes 60 spaced approximately 60° apart formed in walls 63 of the conduit, as seen in FIG. 6. The conduit is secured into position with respect to the housing by bolt 61 or other fastener. Bolt 61 extends through opening 62 formed in arm 64 extending radially outwardly from housing 18. The bolt is received by one of the openings 60 in hexagonal portion 59 as shown in FIG. 6.

As seen in FIG. 4, welding wire 26, surrounded by the helical spring 30, extends through opening 37 formed in conduit 50. Shielding gas travels through tube 31 into cavity 40 of housing 18 and then into the spaced apart holes 54 in groove 52. The gas then travels through opening 37 surrounding the wire 26 and spring 30. The wire initially passes through an opening 65 in a separate conduit 66 which is secured to an end member 67 of conduit 50.

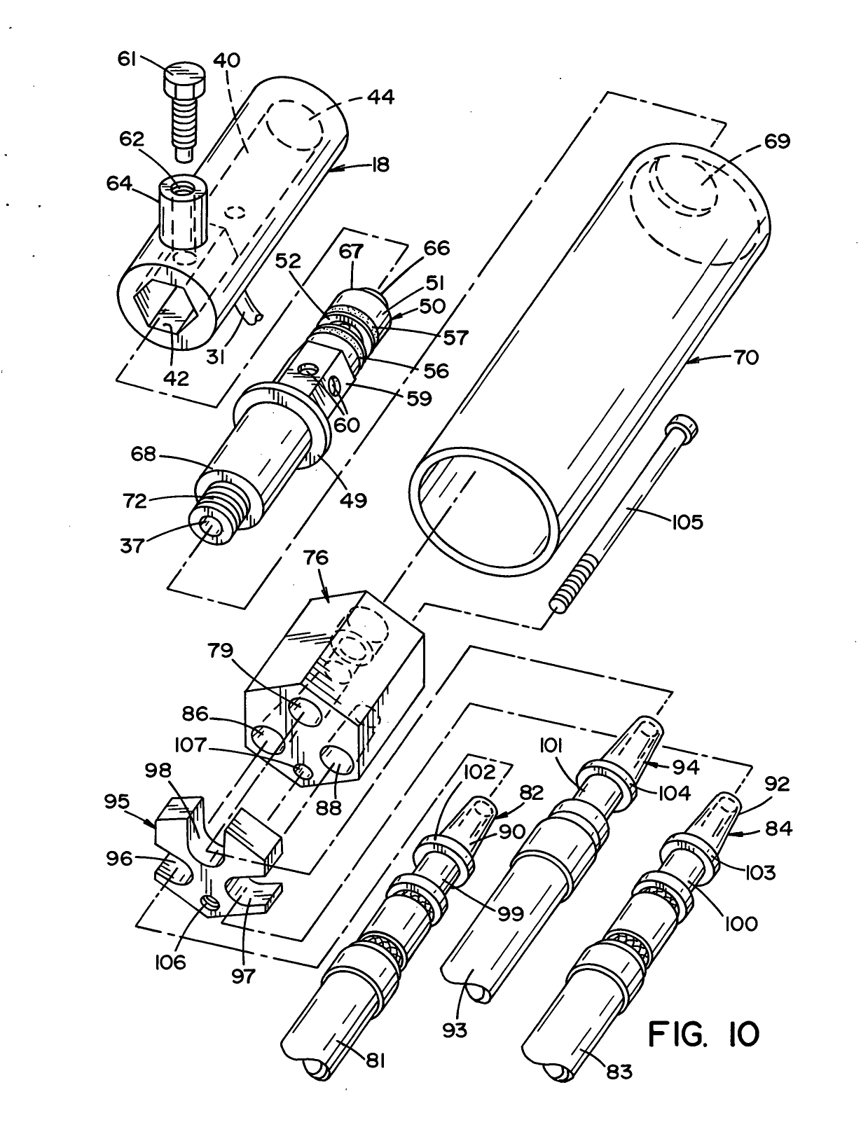

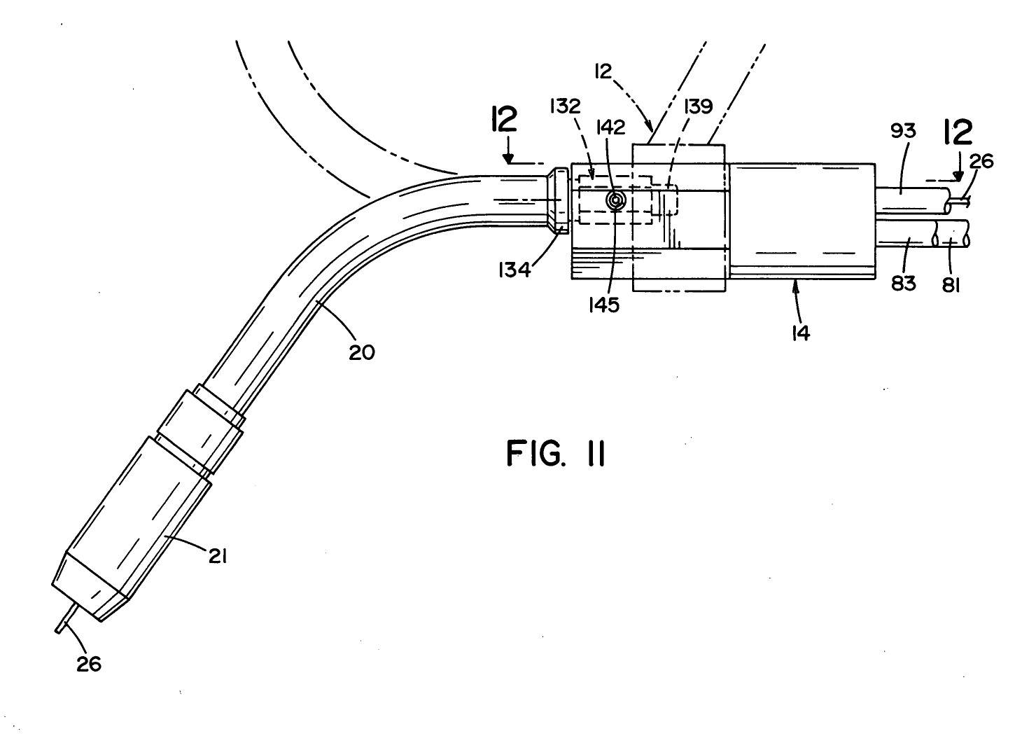

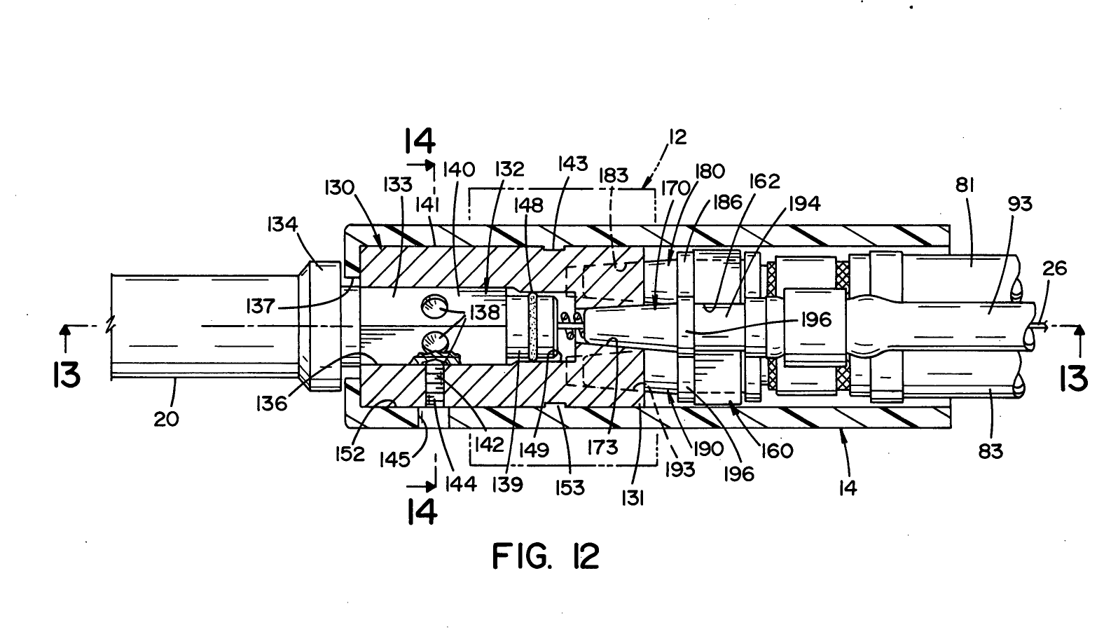

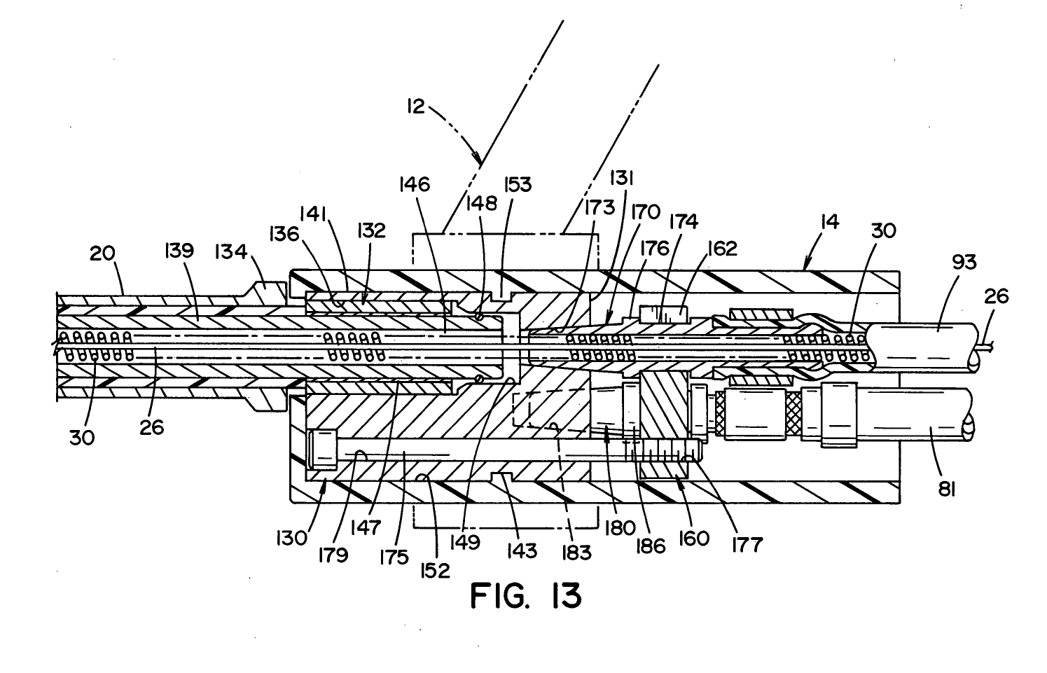

Referring to FIG. 4, end member 68 of conduit 50 extends into opening 69 of cylindrical housing or sleeve portion 70. Sleeve 70 can be made of conventional rubber or a canvas cover. Cylinder end member 68 has a threaded portion 72 which is threadably engaged with a corresponding threaded opening 74 in a mating first block 76 housed within another sleeve. Block 76 is also preferably formed of brass. A collar or flange 49 extends from the conduit 50 and abuts an end wall of the housing 18. Referring to FIG. 7, first block 76 is hexagonally shaped and is selectively received within hexagonally shaped opening 78 of sleeve 70. Thus, block 76 can be positioned in one of six positions approximately 60 degrees apart with respect to the sleeve. Alternatively, sleeve 70 can be a hollow cylinder as shown in FIG. 10. Block 76 can then be rotated within sleeve 70 to a variety of positions.

Referring to FIG. 9, pipe-spigots 82, 84 are formed on feed ends of conventionally used power cables 81, 83 which extend through the welding gun sleeve 70. The pipe-spigots are inserted into sockets 86, 88 formed in end wall 73 of first block 76. Plug ends 90, 92 of the pipe-spigots are taper fit into the sockets 86, 88. Referring to FIG. 4, first block 76 also has a conically-shaped socket 79 for receiving a tip or pipe-spigot 94 of welding wire feed tube 93.

When the plug-ends 90, 92 are inserted tightly in the sockets 86, 88, not only are the pipe-spigots secured very well mechanically to the block, but also there is an excellent, low resistance, electrical contact between the pipe-spigots and the block. A length of flexible electrical cable is brazed or soldered into a hole in the pipe-spigots.

As compared with a single cable, dividing the electrical duty between two cables means that each cable can be a little less than half the current-carrying cross-section than the corresponding single cable. The reason each half-cable can be a little less than half the size is that each half-cable is contained in its own respective jacket, whereby cooling of the cable can be enhanced.

When only a single cable was provided, as in conventional designs, the conduit could be quite stiff. As a result, the welding operator found it quite tiring to operate the torch through a working day.

Splitting the cable into two and using two smaller-than-half cables, results in a greater improvement in physical flexibility and manipulability to the conduit; so much so as to extend by hours the period the operator can work comfortably.

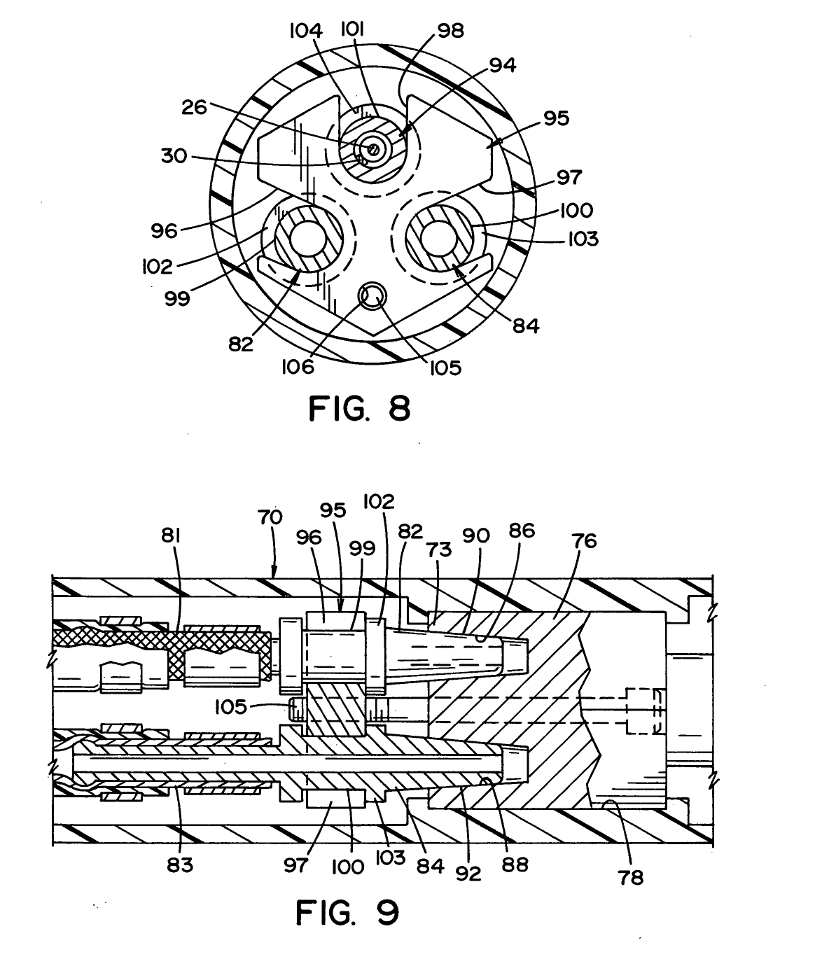

In order to ensure the pipe-spigots 82, 84, 94 are pressed firmly into the sockets 79, 86, 88, a plate or draw-ring 95, preferably formed of steel, is provided as shown in FIG. 8 and 10. The approximately hexagonal shaped draw-ring has substantially U-shaped slots or cut-outs 96, 97, 98 which engage complementary recesses 99, 100, 101 defined between collars 102, 103, 104 provided on the pipe-spigots.

The draw-ring 95 is separate from the block and can move slightly with respect to the block to adjust the position of the pipe-spigots. When the draw-ring is moved to the right, it urges the pipe-spigots tightly into the sockets 79, 86, 88 in the block 76; when the draw-ring is forced to the left, it disengages the pipe-spigots from the block. The draw-ring 95 is moved to the right by tightening a bolt 105 which is inserted into an opening 106 in the ring and into a corresponding opening 107 in the block. To move the draw-ring to the left, the bolt 105 is slackened, and then the head of the bolt may be tapped to the left to drive the pipe-spigots free from the sockets. (The angle of the taper in the sockets is such that the taper is self-locking). The bolt 105 is screw-threaded into the draw-ring 95 and passes through corresponding plain hole 107 in the block 76.

As described, the cable and wire assembly includes the welding wire inside its guide spring surrounded by tubing 93; and the two electrical cables inside their respective tubes 81, 83. It will be noted that the three flexible pipes or tubes 81, 83, 93 can all have respective central internal “cores” of metal; these “cores” serve to provide excellent resistance to kinking of the pipes and tubes and to other types of mechanical failure. The entire wire and cable assembly is enclosed in sleeve 70.

The wire and cable assembly is therefore very sturdy in the sense of being able to resist the abuse which is always likely to be imposed upon it in a practical welding shop, especially abuse such as snagging, twisting, and the like. On the other hand, none of the components of the wire and cable are thick or heavy, and therefore the assembly is light in weight, and is comparatively very flexible. It is easy for the operator to carry and manipulate a welding torch supported on such an assembly for long periods.

The components shown in FIG. 10 can possibly be fit inside a plastic handle of conventional type. A trigger is typically included in the handle, which, when operated, activates the welding current, starts the wire feed-motor, etc., back at the service station.

The other front or supply end of the welding gun, adjacent to the welding torch, will now be described. At the service station or feed end of the welding gun as shown in FIG. 1, the requirement, as far as the physical characteristics of the components was concerned, was to support the conduit of wire and cables in a secure, robust fashion. At the torch end of the conduit, on the other hand, the requirements are different, in that now the main requirement is that the components should be light in weight; the components also should be physically small, especially as regards radial dimensions. The gooseneck 20 extends between the torch nozzle 21 and first or front housing 14. Referring to FIG. 12, a second block 130, formed of brass, is secured to an end portion of second conduit 132 which extends from end 134 of the gooseneck. Hexagonally shaped second conduit 132, also formed of brass, is selectively received within corresponding hexagonal opening 136 of block 130 and through round or circular opening 137 of plastic housing 14. The block 130 has a groove 143 which can receive a rib or protrusion 153 formed on the inner wall of housing 14 to secure the block within the housing.

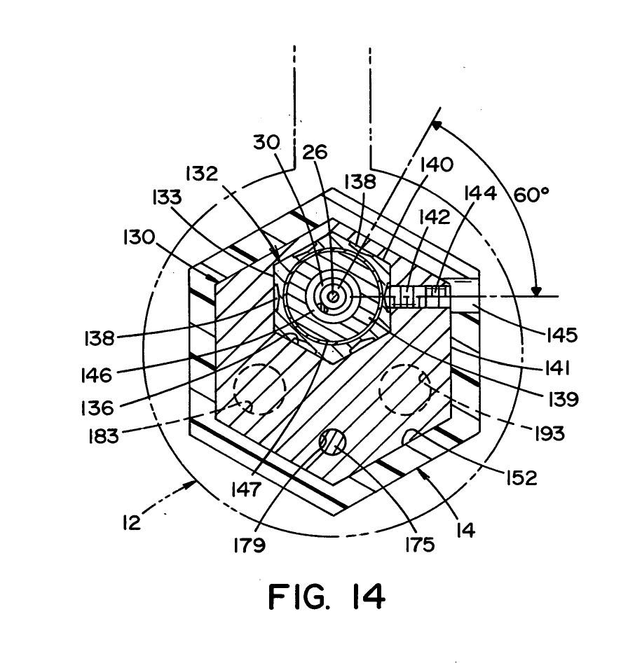

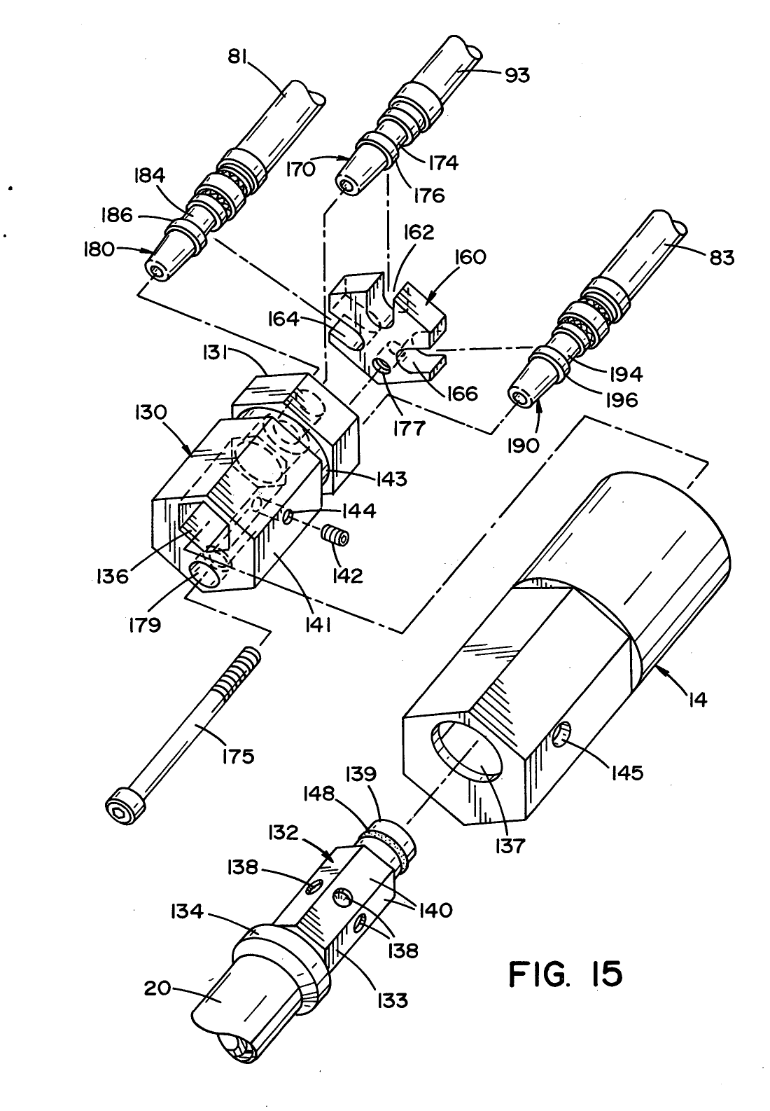

Referring to FIGS. 14 and 15, the conduit 132 has six openings 138 which are spaced approximately 60 degrees apart on six side walls 140 of the conduit. A bolt 142 or other suitable fastener extends through an opening 144 formed in one of side walls 143 of block 130 and an opening 145 in housing 14 and extends into one of the openings 138 of the conduit to secure the conduit in one of six positions approximately 60 degrees apart with respect to the block 130. A copper tube 139 extends through the conduit 132 and is cylindrical in shape. The tube is soldered with solder 147 to conduit 130. The tube 139 receives the welding wire 26 and spring 30 through opening 146 and extends into gooseneck 20. An O-ring 148 is provided to seal the tube 139 within opening 149 of block 130.

A second plate or draw-ring 160 has cut-outs or U-shaped slots 162, 164, 166 for accommodating recesses 174, 184, 194 between collars 176, 186, 196, respectively, of pipe-spigots 170, 180, 190 at supply ends of the power cables 81, 83 and welding wire tube 93, as was described with respect to the pipe-spigots shown in FIG. 10. A bolt or elongated fastener 175 extends through opening 177 of the draw-ring for moving the draw-ring, and thereby clamping the pipe-spigots into the block 130 through opening 179 of second block 130.

As clearly shown in FIGS. 14 and 15, the shape of the second block 130 is hexagonal. Plastic housing or sleeve 14 has a corresponding hexagonal shaped opening 152 which accommodates and provides insulation to the block. Housing 14 has a hexagonal shape to be received in one of six positions with respect to a hexagonal mounting arm bracket of a robotic arm 10. Such a robotic arm assembly is discussed in co-pending application Ser. No. 11/178/819, filed on Jul. 11, 2005, incorporated herein by reference. The block 130 also has a hexagonally shaped opening 136 formed at an upper end which accommodates conduit 132 which has a hexagonally shaped portion 133 formed by side walls 140.

The pipe-spigots 170, 180, 190 may be secured into the block 130 by means of the tapered sockets 173, 183, 193 formed in end wall 131 of block 130, as shown, or, alternatively, the pipe-spigots may be secured into a block by means of screw-threads. The block 130, preferably made of brass, and the plugs are brazed into the drilling as required: as a general rule in welding torches, the use of rubber seals should be avoided except where the sealed components have to be detachable. Because of the very tight restriction on the radial space envelope in the torch handle, the room available for the spigot-to-block connection, whatever its structure is severely limited. It is recognized that if this small space were occupied by a screw-thread connection, the constraints would be so tight that the screw-thread connection at that location would be unreliable. That is, if the pipe-spigot were secured into the block by means of a screw-thread connection, the screw-thread would be so small that there would be a danger that the thread would strip, even with just a small degree of abuse. It may be noted also that the components in question are generally made of brass, which material has no great resistance to the stripping of threads if over-tightened.

The connection as described has good electrical properties. When assembled, the pipe-spigot becomes tightly wedged into the socket, which gives an excellent, large-contact-area, electrical connection for the heavy welding currents.

Preferably, the pipe-spigots at the service-station end should be identical to the spigots at the torch end. Although there is no premium on radial space at the service station end of the conduit, it is simpler to have components the same.

Although two electrical power pipes have been described, more than two may be provided. The draw-ring and draw bolt arrangement can be used to tighten more than two pipe-spigots into place (simultaneously) into suitable sockets.

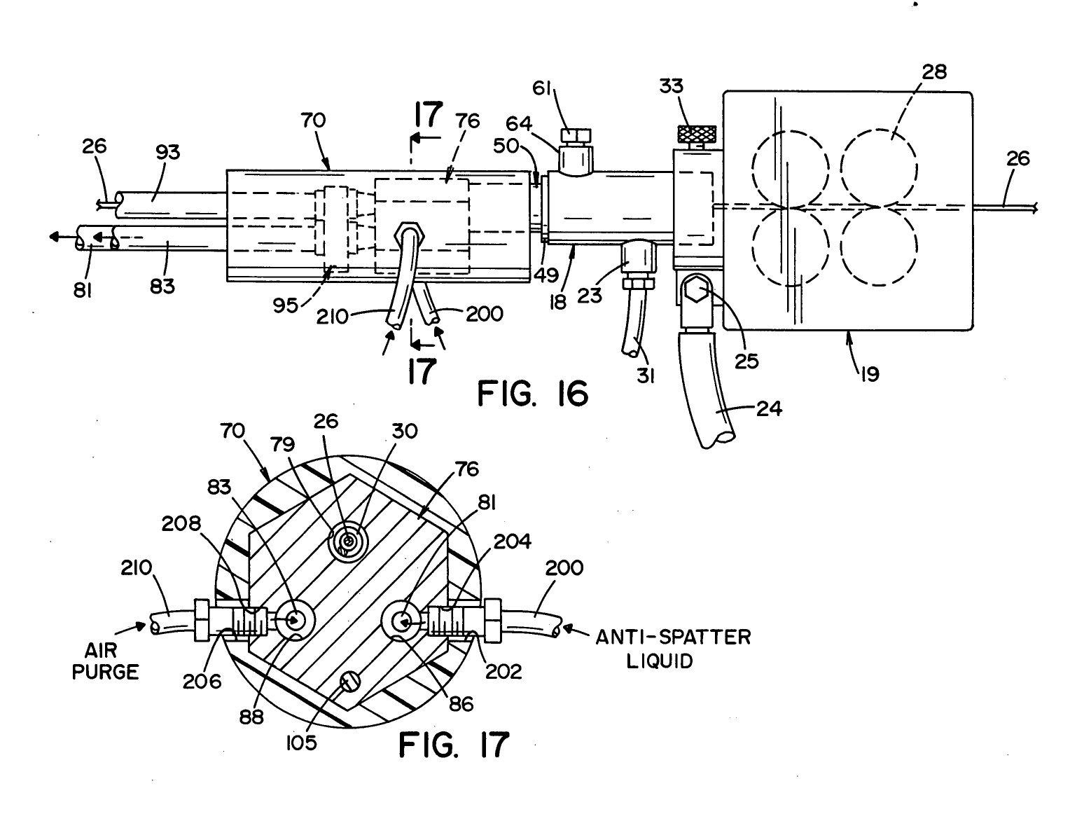

Referring now to FIGS. 16-17, an alternative embodiment is shown. Occasionally, spatter from welding at the contact tip may travel through the gooseneck 20 and into the power cables or tubes 81, 83 or into the welding wire tube 93. To prevent this trend from occurring, additional feed lines 200, 210 may be attached to sleeve 70. Specifically, a tube 200 may be inserted through an opening 202 in sleeve 70 and threadably connected to an opening 204 in block 76. Opening 204 in turn is fluidly connected to openings 88 for pipe spigot 81. Tube 210 is also inserted through opening 206 in sleeve 70 and is threadably connected to opening 208 in block 76. Opening 208 in turn is fluidly connected to opening 89 for pipe-spigot 83.

Tube 200 is used to feed an anti-spatter liquid into opening 88 for power cable 81. The anti-spatter liquid travels through opening 88 and prevents spatter from entering and building up in the power cable opening. An example of anti-spatter liquid is robotic anti-spatter liquid provided by Clearco of 3430 G Progress Drive, Bensalem, Pa. 19020. The anti-spatter liquid may contain synthetic release agents to prevent hot spatter from sticking within the welding gun.

Tube 210 can be used to feed an air purge through opening 89 for power cable 83. The air purge serves to purge excess spatter and air out of the cable line.

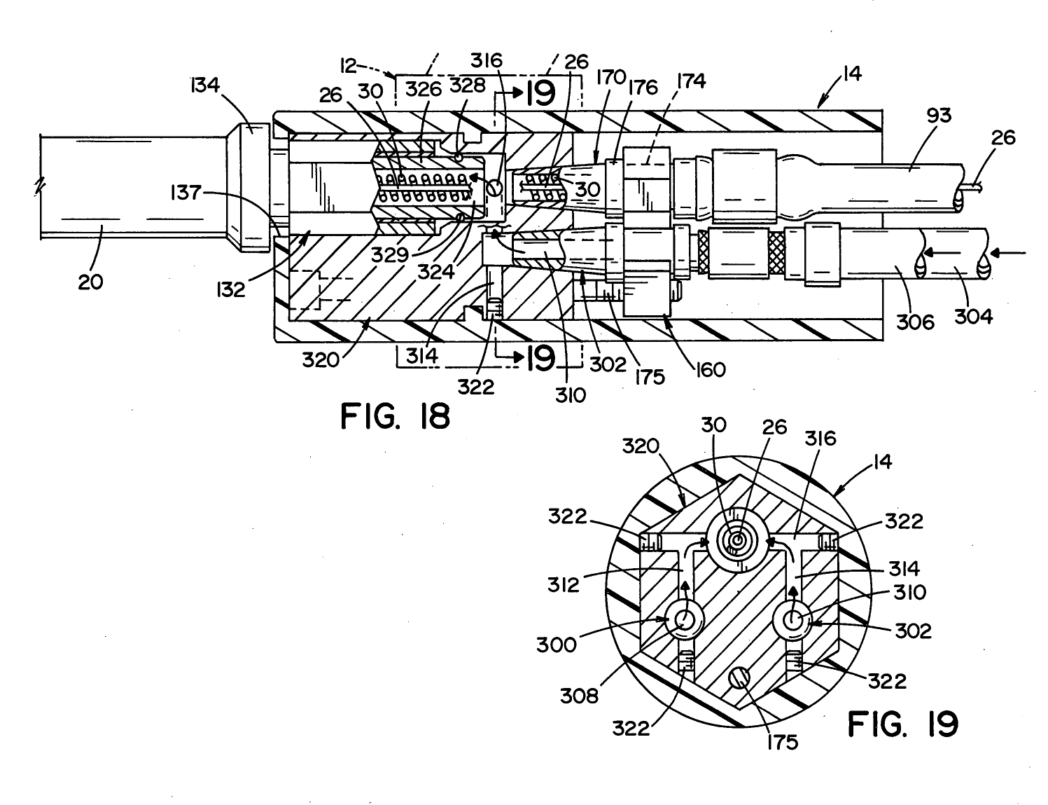

Another alternative embodiment is shown in FIGS. 18 and 19. Pipe spigots 300, 302 provided at the ends of the power cables 304, 306 each has an opening 308, 310 for allowing an air purge or anti-spatter liquid to travel through and out of the cables into a series of passageways 312, 314, 316 which are drilled into block 320. As shown in FIG. 19, the passageways 312 and 314 are substantially parallel to each other and are perpendicular to passageway 316 and are all interconnected to each other. However, other configurations can be used without departing from the scope of the invention. Dowels or end caps 322 or other suitable plugs are used to plug or seal the ends of the passageways to prevent gas and liquid from escaping from block 320.

The shielding gas or anti-spatter liquid travels through the cables into the passageways 312, 314, 316 via openings 308, 310 and into opening 324 of conduit 326 which is mounted within block 320. The welding wire 26 and spring 30 pass through opening 324 and are surrounded by the shielding gas. An O-ring 328 is positioned in a groove 329 on the conduit 326 to prevent the gas or liquid from traveling outside the conduit.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A welding gun assembly for directing a welding wire toward a workpiece, comprising:
a torch at a forward portion of the gun;
a welding wire feeder at a rearward portion of the gun;
a first housing positioned adjacent said torch;
a second housing positioned adjacent said wire feeder;
said second housing comprising:
a first, cylindrical opening and a second, hexagonally shaped opening adjacent said first opening;
a first conduit selectively received within said second housing, said conduit having a first, cylindrical portion and a second, hexagonal portion comprising a plurality of outer walls, said first cylindrical portion received within said cylindrical opening of said second housing and said second, hexagonal portion received within said hexagonal opening of said second housing;
said first conduit further having an opening therethrough for receiving welding wire; and
said second housing comprising an opening in a wall thereof to receive shielding gas to a cavity of said second housing formed by said cylindrical opening and said hexagonal opening.

2. The welding gun assembly of claim 1, wherein said first conduit comprises a plurality of openings on said outer walls of said second, hexagonal portion of said first conduit.

3. The welding gun assembly of claim 2, wherein said second housing comprises an arm with an opening therethrough for receiving a fastener, wherein said fastener is received by one of said openings on said outer walls of said second, hexagon portion of said first conduit for securing said first conduit in one of six positions with respect to said second housing.

4. The welding gun assembly of claim 1, wherein said first conduit comprises a plurality of openings spaced apart on an outer surface of said cylindrical portion of said first conduit forming passageways for shielding gas.

5. The welding gun assembly of claim 4, wherein said openings on said outer surface of said cylindrical portion of first conduit are spaced approximately 90 degrees apart.

6. The welding gun assembly of claim 4, wherein said first conduit comprises at least one O-ring mounted adjacent said openings in said outer surface of said cylindrical portion of said first conduit.

7. The welding gun assembly of claim 1, wherein said first conduit further comprises an extension extending from an end of said first conduit, said extension comprising a threaded outer surface and an opening therethrough.

8. The welding gun assembly of claim 7, wherein said first conduit further comprises a flange which extends from an outer surface of said first conduit and abuts an outer edge of said second housing.

9. The welding gun assembly of claim 7, further comprising a hexagonally shaped first block comprising a threaded opening formed in an end wall thereof for receiving said threaded extension of said first conduit.

10. The welding gun assembly of claim 9, wherein said first block comprises a plurality of sockets formed in an end wall of said first block for receiving associated pipe-spigots of associated power cables.

11. The welding gun assembly of claim 10, wherein said first block further comprises an opening in said end wall for receiving a fastener therein.

12. The welding gun assembly of claim 11, further comprising a first end plate having an opening therein for receiving said fastener and connecting said end plate to said first block.

13. The welding gun assembly of claim 12, wherein said first end plate comprises a plurality of slots for receiving said pipe-spigots of said cables.

14. The welding gun assembly of claim 10, wherein said sockets of said first block are tapered.

15. The welding gun assembly of claim 13, wherein said slots of said end plate are substantially U-shaped.

16. The welding gun assembly of claim 12, further comprising a sleeve having a hexagonal opening which covers said first block and said first end plate and said threaded extension of said conduit.

17. The welding gun assembly of claim 16, wherein said sleeve comprises an end wall having an opening therein for receiving said threaded extension of said first conduit.

18. The welding gun assembly of claim 12, wherein said first end plate is approximately hexagonally shaped.

19. The welding gun assembly of claim 10, wherein said first block further comprises a socket for receiving a pipe-spigot for a welding wire tube therein.

20. The welding gun assembly of claim 13, wherein said first end plate further comprises a slot for receiving a pipe-spigot of a welding wire tube therein.

21. The welding gun assembly of claim 1, further comprising a tube threadably mounted to said opening on said second housing for receiving shielding gas.

22. The welding gun assembly of claim 17, wherein said first block can be mounted in one of six positions approximately 60 degrees apart with respect to said sleeve hexagonal opening.

23. The welding gun assembly of claim 12, wherein said first housing comprises a hexagonally shaped portion and a cylindrical shaped portion adjacent said hexagonal position.

24. The welding gun assembly of claim 23, further comprising a second block having a plurality of side walls forming a hexagonal shape.

25. The welding gun assembly of claim 24, wherein said second block comprises a groove formed on an outer surface thereof.

26. The welding gun assembly of claim 24, wherein said second block comprises a hexagonal shaped opening therein.

27. The welding gun assembly of claim 26, further comprising a second conduit having a hexagonal shaped portion and a cylindrically shaped portion adjacent to and extending through said hexagonal portion, wherein said hexagonal portion is selectively received within said hexagonal shaped opening of said second block.

28. The welding gun assembly of claim 27, wherein said second conduit hexagonal portion comprises a plurality of walls, each having an opening therein.

29. The welding gun assembly of claim 26, wherein one of said side walls of said second block comprises an opening therein.

30. The welding gun assembly of claim 29, wherein said first housing comprises an opening formed in a side wall of said hexagonal portion of said first housing.

31. The welding gun assembly of claim 30, wherein one of said openings in said hexagonal portion of said second conduit aligns with said opening of said second block and said opening of said first housing, wherein a fastener is inserted through said one of said openings in said hexagonal position of said second conduit and through said opening of said second block and second opening of said first housing, to secure said second conduit in one of six positions with respect to said second block and said first housing.

32. The welding gun assembly of claim 31, wherein said first housing comprises an end wall formed on said hexagonal portion, said end wall having an opening therethrough for selectively receiving said second conduit.

33. The welding gun assembly of claim 27, wherein said cylindrical portion of said second conduit comprises an O-ring positioned on an outer surface thereof.

34. The welding gun assembly of claim 25, wherein said second block comprises an opening formed in a side wall of said block for receiving an elongated fastener.

35. The welding gun assembly of claim 34, further comprising a second end plate having an opening therein for receiving said elongated fastener and connecting said second end plate to said second block.

36. The welding gun assembly of claim 35, wherein said second end plate comprises a plurality of slots for receiving pipe-spigots of associated power cables.

37. The welding gun assembly of claim 36, wherein said second end plate comprises a slot for receiving a pipe-spigot of a welding wire tube.

38. The welding gun assembly of claim 9, wherein said first block comprises a passageway in one of outer walls of said first block for receiving an outlet of an anti-spatter liquid supply tube.

39. The welding gun assembly of claim 9, wherein said first block comprises a passageway formed in one of outer walls of said first block for receiving an outlet of an air purging tube.

40. The welding gun assembly of claim 16, wherein said sleeve comprises a passageway formed in an outer wall for receiving an outlet of an anti-spatter liquid supply tube.

41. The welding gun assembly of claim 16, wherein said sleeve comprises a passageway formed in an outer wall for receiving an outlet of an air purging tube.

42. The welding gun assembly of claim 24, wherein said second block comprises a plurality of sockets formed in an end wall thereof for receiving associated pipe-spigots of associated power cables and a pipe-spigot of a welding wire tube.

43. The welding gun assembly of claim 42, wherein said second block comprises a passageway fluidly connecting one of said sockets for said pipe-spigots of said power cables to said socket for said pipe-spigot for said welding wire tube, wherein said passageway feeds anti-spatter liquid to said pipe-spigot for said welding wire tube.

44. The welding gun assembly of claim 43, wherein said second block comprises a passageway for fluidly connecting the other of said pipe-spigots of said power cables to said socket for said pipe-spigot for said welding wire tube, wherein said passageway feeds anti-spatter liquid to said pipe-spigot for said welding wire tube.

45. The welding gun assembly of claim 42, wherein said second block comprises a passageway fluidly connecting one of said sockets for said pipe-spigots of said power cables to said socket for said pipe-spigot for said welding wire tube, wherein said passageway feeds an air purge to said pipe-spigot for said welding wire tube.

46. The welding gun assembly of claim 45, wherein said second block comprises a passageway for fluidly connecting the other of said pipe-spigots of said power cables to said socket for said pipe-spigot for said welding wire tube, wherein said passageway feeds an air purge to said pipe-spigot for said welding wire tube.

47. The welding gun assembly of claim 24, wherein said second block is positioned within one of six positions in a hexagonally shaped opening of said first housing.

48. A housing assembly for use with a welding gun assembly for directing a welding wire toward a workpiece, comprising:
a housing having a first, cylindrical opening and a second, hexagonally shaped opening adjacent said first opening;
a conduit selectively received within said housing, said conduit having a first cylindrical portion and a second hexagonal portion comprising a plurality of outer walls, said first cylindrical portion received within said cylindrical opening of said housing and said second, hexagonal portion received within said hexagonal opening of said housing;
said conduit further having an opening formed in each of said outer walls; and
said housing comprising an opening in a wall thereof to receive a fastener extending therethrough, said housing opening is aligned with one of said openings in said outer walls of said conduit and said fastener extends through said housing opening and said one of said openings of said outer walls of said conduit to secure said conduit to said housing.

49. The housing assembly of claim 48, wherein said conduit comprises an opening for receiving welding wire.

50. The housing assembly of claim 48, wherein said housing further comprises an opening in an outer wall thereof to receive shielding gas.

51. The housing assembly of claim 48, wherein said conduit comprises a plurality of openings spaced apart on an outer surface of said cylindrical portion of said conduit forming a passageway for shielding gas.

52. The housing assembly of claim 51, wherein said openings on said outer surface of said cylindrical portion of said conduit are spaced approximately 90 degrees apart.

53. The housing assembly of claim 51, wherein said conduit comprises at least one O-ring mounted adjacent said openings in said outer surface of said cylindrical portion of said conduit.

54. A housing assembly for use with a welding gun assembly for directing a welding wire toward a workpiece, comprising:
a housing comprising a first hexagonal portion;
a block having a plurality of side walls forming a hexagonal shape; said block having a hexagonal shaped opening therein;
a conduit having a hexagonal shaped portion and a cylindrically shaped portion adjacent to and extending through said hexagonal portion of said conduit, wherein said hexagonal portion is selectively received within said hexagonal shaped opening of said block.

55. The housing assembly of claim 54, wherein said conduit hexagonal shaped portion comprises a plurality of walls, each having an opening therein.

56. The housing assembly of claim 55, wherein one of said side walls of said block comprises an opening therein.

57. The housing assembly of claim 56, wherein said housing comprises an opening formed in a side wall of said hexagonal portion of said housing.

58. The housing assembly of claim 57, wherein one of said openings in said hexagonal portion of said conduit align with said opening in one of said walls of said block and said opening of said housing, wherein a fastener is inserted through said one of said openings in said hexagonal position of said conduit, through said opening of said block and through said opening of said housing to secure said conduit in one of six positions with respect to said block and said housing.

59. The housing assembly of claim 54, wherein said housing comprises an end wall formed on said hexagonal portion, said end wall having an opening therethrough for selectively receiving said conduit.

60. The housing assembly of claim 54, wherein said housing comprises a hexagonally shaped cavity for receiving said block.

61. The housing assembly of claim 54, wherein said housing hexagonal portion is adapted to be mounted in a hexagonal mounting bracket of a robotic arm.

62. A welding gun assembly comprising a housing; a conduit extending through said housing; a block housed within said housing, wherein said block comprises a passageway in one of outer walls of said block for receiving an outlet of an anti-spatter liquid supply tube.

63. The welding gun assembly of claim 62, wherein said block comprises a passageway formed in one of outer walls of said block for receiving an outlet of an air purging tube.

64. The welding gun assembly of claim 62, wherein said housing comprises a passageway formed in an outer wall for receiving an outlet of an anti-spatter liquid supply tube.

65. The welding gun assembly of claim 62, wherein said housing comprising a passageway formed in an outer wall for receiving an outlet of an air purging tube.

66. A welding gun assembly comprising:
a housing, a block mounted within the housing, wherein said block comprising a plurality of sockets for receiving pipe-spigots of associated power cables and a welding wire tube, wherein said block comprises a passageway fluidly connecting one of said sockets for said pipe-spigots of said power cables to said socket for said pipe-spigot for said welding wire tube, wherein said passageway feeds anti-spatter liquid to said pipe-spigot for said welding wire tube.

67. The welding gun assembly of claim 66, wherein said block comprises a passageway for fluidly connecting the other of said pipe-spigots of said power cables to said socket for said pipe-spigot for said welding wire tube, wherein said passageway feeds anti-spatter liquid to said pipe-spigot for said welding wire tube.

68. The welding gun assembly of claim 67, wherein said block comprises a passageway interconnecting each of said passageways between said pipe-spigots of said power cables and said welding wire tube.

69. The welding gun assembly of claim 66, wherein said block comprises a passageway fluidly connecting one of said sockets for said pipe-spigots of said power cables to said socket for said pipe-spigot for said welding wire tube, wherein said passageway feeds an air purge to said pipe-spigot for said welding wire tube.
